(19) United States
(12) Patent Application Publication
(10) Pub. No.: US 2010/0017313 A1
(43) Pub. Date: Jan. 21, 2010

(54) Foldable, One-Piece Mailer and Methods of Use Thereof

(76) Inventors: Kurt Mosenthiem, Van Nuys, CA (US); Joshua Saffren, North Hollywood, CA (US)

Correspondence Address: CARSTENS & CAHOON, LLP, P O BOX 802334, DALLAS, TX, 75380, US

(21) Appl. No.: 12/505,214

(22) Filed: Jul. 17, 2009

Related U.S. Application Data
(60) Provisional application No. 61/081,650, filed on Jul. 17, 2008.

(51) Int. Cl. G06Q 50/00; B65D 27/00; G06Q 10/00

(52) U.S. Cl. 705/28; 229/75; 705/30

(57) ABSTRACT

Disclosed herein is a foldable, one-piece mailer having at least one portion thereof that may be easily detached and retained by a recipient. The mailer comprises a sheet having a front side for placing postage and indicating the recipient's address, and a back side that includes space for printing text to the recipient. On the back side of the mailer appears a means for visibly indicating sections of the mailer that are intended to be folded for mailing. Such means may include dotted lines, pre-formed creases, or any other indicator that delineates the sections that should be folded by a user to form the mailer into a shape resembling an envelope. The detachable portion of the mailer is removably secured to the mailer so that it can be removed by the recipient and retained. Methods for collecting information pertaining to the manufacture and sale of said mailers are also disclosed.

### CROSS-REFERENCE TO RELATED APPLICATION

This application claims the benefit of U.S. Provisional Application No. 61/081,650, filed Jul. 17, 2008, which is incorporated by reference herein.

### BACKGROUND OF THE INVENTION

1. Field of the Invention

The present invention relates generally to a mailer and more specifically, to a foldable, one-piece mailer having a detachable portion thereof, said mailer being constructed from a single piece of material that can be written on and then folded into an envelope that is suitable for mailing.

2. Description of the Related Art

In recent years, there has been a steady increase in the number of persons who utilize electronic mail (e-mail) for most of their written correspondence. As a result, many have begun to view the act of preparing and mailing physical written correspondence as a burdensome task. The burden involved in preparing and mailing written correspondence often involves assembling the necessary elements of the correspondence. In particular, the sender must acquire paper and a writing instrument, an envelope, and stamp(s) for mailing the correspondence.

However, for many, physical written correspondence is still a preferred means of communications because it is viewed as a more personal way of connecting with an individual. Unlike electronic forms of communication, which are often quickly written and easily deleted, physical written correspondence such as a greeting card or a letter enclosing a photograph, is a more endearing form of communication.

Moreover, such physical written correspondence is often a necessity for businesses and other persons that desire to communicate in a manner other than through e-mail. For such businesses and persons, it is sometimes desirable to send correspondence that encloses an additional item that is intended to be retained by the recipient. For example, correspondence soliciting business from a potential customer may have a business card enclosed that is intended to be retained by the recipient. This requires that both the written correspondence and the additional item be separately printed, assembled for mailing, and mailed. The foregoing steps burden the sender with added expenses and increases the time required in which to prepare the correspondence for mailing. Thus, a need exists to ease the burden involved in preparing and sending written correspondence, and more particularly, correspondence enclosing additional items to be retained by the recipient.

At least one possible partial solution to the problem is disclosed in U.S. Pat. No. 4,744,509 to Büchler-Dopheide (hereinafter “the '509 patent”). The '509 patent discloses a foldable letter that can be mailed. A square letter having a plurality of flaps which can be folded to form an item that can easily be mailed is taught. The foldable letter disclosed in the '509 patent makes it easier to prepare and send than regular correspondence as it is not necessary to separately acquire an envelope. However, one potential drawback of the invention disclosed in the '509 patent is that those desiring to utilize the foldable letter taught therein who need to enclose an additional item with said letter, must still separately print, assemble, and mail both the foldable letter and an enclosed item. Another drawback of the letter taught in the '509 patent is that the square dimensions of the letter make it burdensome to print when using most home and office printers that only accept standard 8½×11 inch dimensions.

Additionally, businesses involved in the manufacturing and distribution of materials necessary for written correspondence have a need to collect and store information pertaining to the manufacture and sale, and delivery of one-piece mailers. Such businesses often have limited means of collecting information pertaining to the manufacture, sale, and delivery of such materials. Tracking when and where sales of the materials are made and the method by which the materials are purchased (cash, credit, check, etc.) would assist manufacturers and distributors of written correspondence in maintaining accurate information concerning the sales of their products. Information concerning the sale and delivery of written correspondence materials could also assist law enforcement officers in solving crimes and terrorist acts involving written correspondence. The needs mentioned above have not been adequately addressed by the prior art. Therefore, it is the object of the present invention disclosed herein to remedy the deficiencies found in the prior art.

### BRIEF SUMMARY OF THE INVENTION

Accordingly, there is provided herein, in various embodiments, a foldable, one-piece mailer having at least one portion thereof that may be easily detached and retained by a recipient, and methods for collecting information pertaining to the manufacture and sale of said mailers. The present invention provides for an innovative mailer that can be used to send correspondence to a recipient along with a separate item that is detachable from the mailer. The correspondence and mailer can be printed on a single sheet of paper and thus, are already assembled for mailing. Moreover, the mailer can be printed with a unique coded identifier that can be associated in a database with various information concerning the manufacture and sale of the mailer.

In one aspect of the invention, the mailer is comprised of a single sheet of paper having two sides. A front side of the mailer includes paid postage and places for the sender to indicate the address of the recipient and the return address. A back side of the mailer includes space for writing or printing text correspondence, adhesive strips for sealing the mailer, and a means for visibly indicating sections of the mailer that are intended to be folded for mailing. In particular, the back side of the one-piece mailer has dotted lines or pre-formed creases indicating locations where the sender should fold the mailer in order to form the mailer into a shape that resembles an envelope. Thus, it is not necessary to utilize an envelope in the mailing of the mailer.

In yet another aspect of the invention, the mailer further comprises a detachable portion that is removably attached to the remaining portion of the mailer via perforations in the paper. It is contemplated that the detachable portion may be any item that the sender desires to deliver to the recipient and intends for the recipient to retain separately from whatever written correspondence (if any) is printed or written on the other portion of the mailer.

In a further aspect of the invention, methods for collecting and storing information pertaining to the manufacture and sale of the mailer are disclosed. A unique coded identifier, such as a bar code or other coded symbol, may be printed or otherwise affixed to a side of the mailer at the time the mailer is manufactured. Information concerning the manufacture of the mailer and postage is associated with the unique identifier and stored in a database by the manufacturer. When the mailer is sold by a retailer, additional information concerning the sale of the mailer is associated with the unique identifier by the retailer. The aforesaid information concerning the sale of the mailer is then transmitted to the manufacturer and is stored in the manufacturer's database. When the sender mails the mailer via the postal service, the postal service can verify the payment of postage with the manufacturer and deliver the mailer to the recipient.

### BRIEF DESCRIPTION OF THE SEVERAL VIEWS OF THE DRAWINGS

A more complete understanding of the present invention may be had by reference to the following detailed description when taken in conjunction with the accompanying drawings, wherein:

FIG. 1 shows the front side of a mailer in the unfolded position;

FIG. 2 shows the back side of a mailer without a detachable portion in the unfolded position;

FIG. 3 shows the back side of a mailer without a detachable portion and having one flap thereof folded;

FIG. 4 shows the back side of a mailer without a detachable portion having two flaps thereof folded;

FIG. 5 shows the back side of a mailer without a detachable portion having three flaps thereof folded;

FIG. 6 shows the back side of a mailer without a detachable portion having four flaps thereof folded;

FIG. 7 shows the front side of a preferred embodiment of the mailer of the present invention in a closed position;

FIG. 8 shows the back side of a preferred embodiment of the present invention having a detachable portion; and

FIG. 9 shows a flow diagram illustrating a method for collecting and storing information pertaining to the manufacture and sale of the mailer of the present invention.

Where used in the various figures of the drawings, the same numerals designate the same or similar parts. Furthermore, when the terms “front,” “back,” “first,” “second,” “upper,” “lower,” “height,” “outer,” “inner,” “width,”“length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific width, length, and similar requirements will likewise be within the skill of the art after the following teachings of the present invention have been read and understood.

Preferred embodiments of the foldable, one-piece mailer having a detachable portion (and methods of use thereof) according to the present invention will now be described in detail with reference to the accompanying drawings.

### DETAILED DESCRIPTION OF THE DRAWINGS

The single-piece mailer of the present invention is different from the common prior art postmarked arrangement consisting of envelope, contents, and paid postage. The invention combines all three elements of stationery with a detachable portion, envelope, and postage into a single physical product, providing both convenience and cost savings.

The mailer itself is unique. Consisting of a single sheet of paper having two sides; pre-stamped for postage on one side; blank on the other, that when folded on the dotted lines and sealed becomes an envelope ready to be mailed from any location to anywhere in the world. In the preferred embodiment, the mailer has standard 8½×11 inch dimensions (width and length, respectively), allowing for easy printing using most home and office printers. A detachable portion of the mailer may be removed and retained by the recipient and the remaining portion of the mailer may be optionally discarded. The uniqueness of the mailer provides several areas of innovation within the context of the mail transport system that has been in operation successfully and consistently for nearly 200 years.

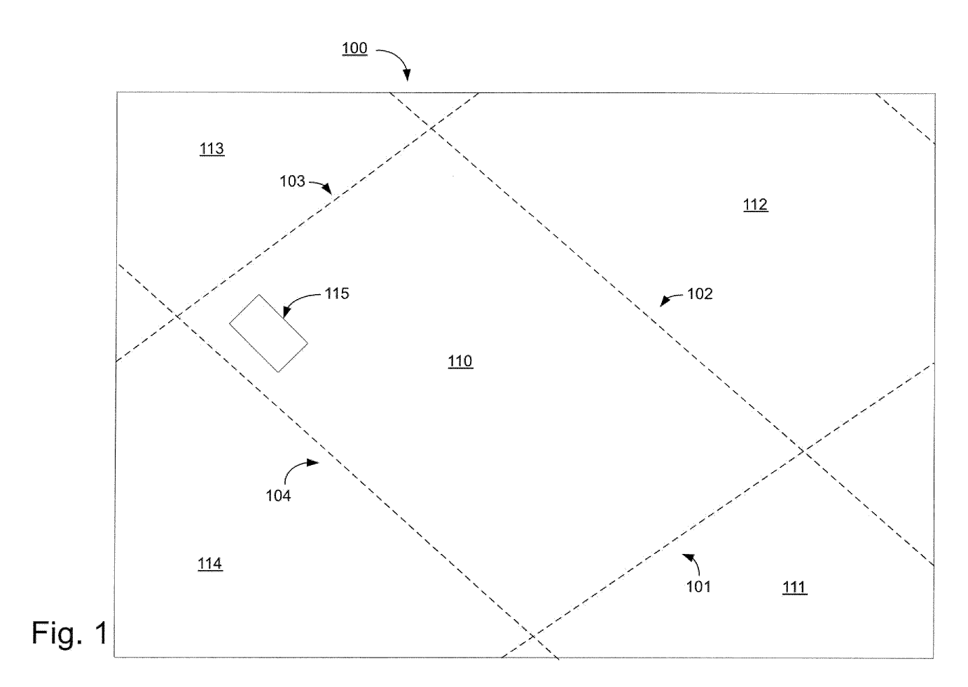

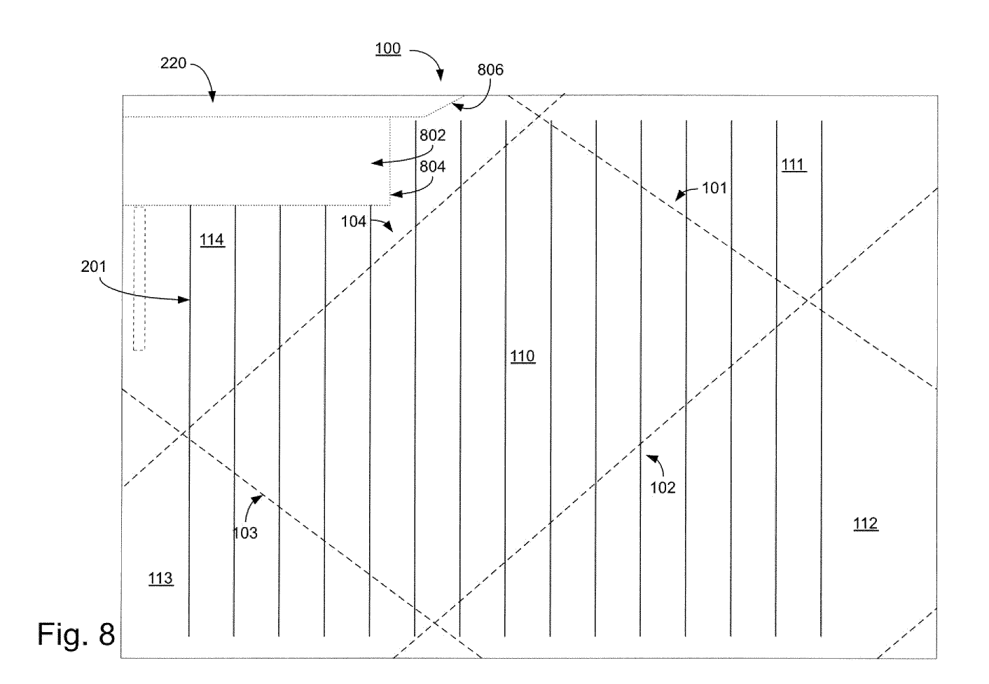

FIGS. 1-7 illustrate generally how the mailer of the present invention may be folded so as to form an enveloped shaped item for mailing. Please note that for the purposes of illustrating how a one-piece mailer may be folded, FIGS. 1-7 have been shown without a detachable portion that is found on the preferred embodiment of the present invention as shown in FIG. 8. FIGS. 1-7 also do not illustrate a preferred embodiment of the mailer with respect to the placement of adhesive strips 220 (see FIG. 8 for preferred embodiment of mailer). However, it should be noted that the preferred embodiment of the mailer of the present invention is folded in preparation for mailing in the manner described below with reference to FIGS. 1-7.

FIG. 1 shows the front side of a mailer (without the detached portion) in the unfolded position. The mailer includes a means for visibly indicating sections of the mailer that are intended to be folded for mailing. The dotted lines 101-104 represent the lines along which the sections of the mailer 100 are folded. These lines may be printed on the mailer 100 to inform the user where to make the folds. In another embodiment, the mailer 100 can be made with creases along the fold lines for easier folding, with or without lines printed along the creases. The lines/creases essentially divide the mailer 100 into several sections or flaps 110-114.

Also shown in FIG. 1 is the preprinted postage 115 on the mailer 100.

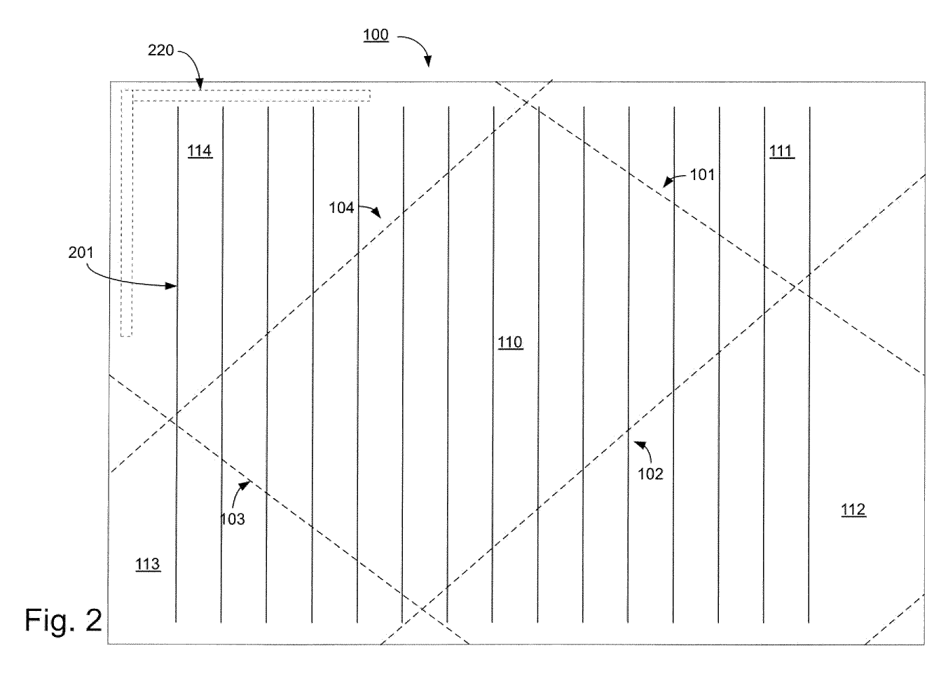

FIG. 2 shows the back side of the mailer (without the detached portion). The dotted lines 101-104 are illustrated in FIG. 2 for reference to show where the folds occur but would preferably not be printed on the back side of the mailer to facilitating reading and writing. This side of the mailer serves as the stationery upon which the user writes. In the example show in FIG. 2, the back side has ruled lines 201 for writing. These lines are optional and will depend upon the stylistic design of the mailer. Since the mailer 100 combines the stationery with the envelop itself, the backside of the mailer shown in FIG. 2 may have various colors and designs just as with regular stationery. In addition, the weight and grain of paper used may vary according to user preferences.

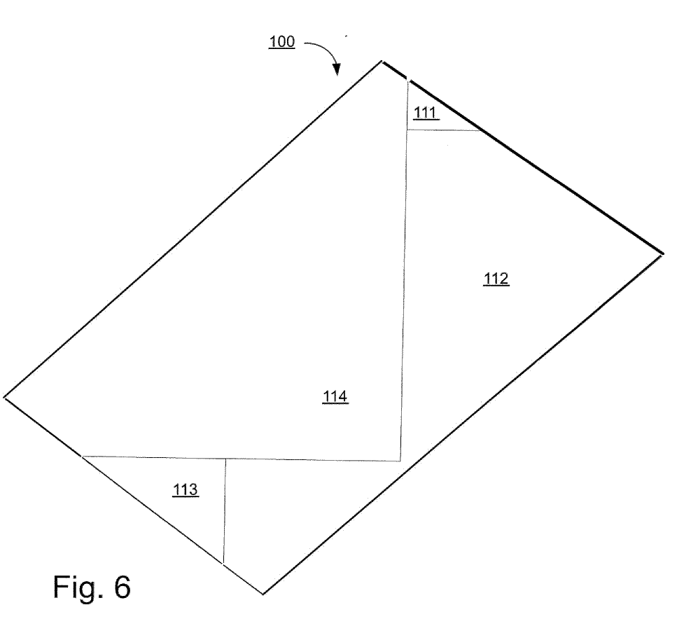

Also shown in FIG. 2 is an adhesive strip 220 used to seal the envelope in the closed position (see FIG. 6). The adhesive strip 220 may comprise a wettable adhesive that the user licks or wets or it may comprise an adhesive with a peal away cover.

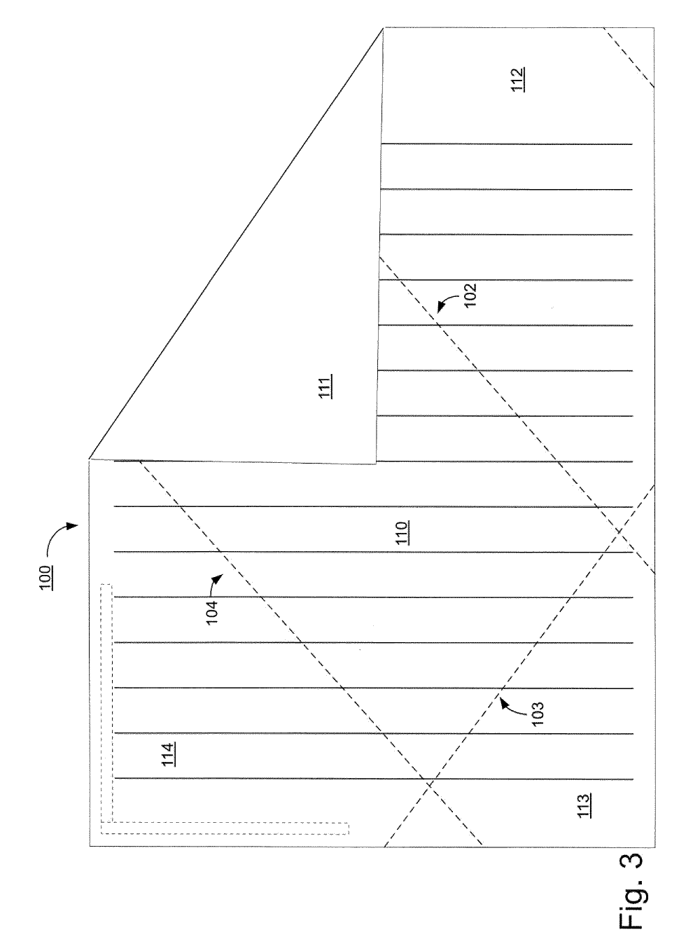

FIGS. 3 through 6 illustrate how the mailer is folded to form an envelope suitable for mailing.

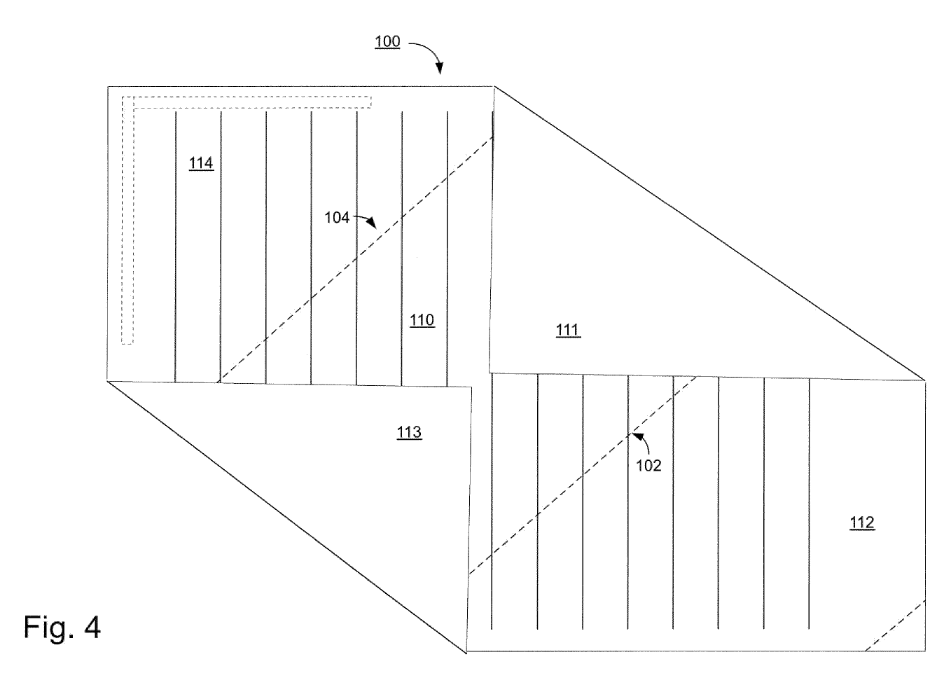

In FIG. 3, flap 111 is folded toward the center section 110 along line 101. In FIG. 4, flap 113 is folded toward the center 110 along line 103. Since flaps 111 and 113 are the inside flaps, it does matter which one is folded first.

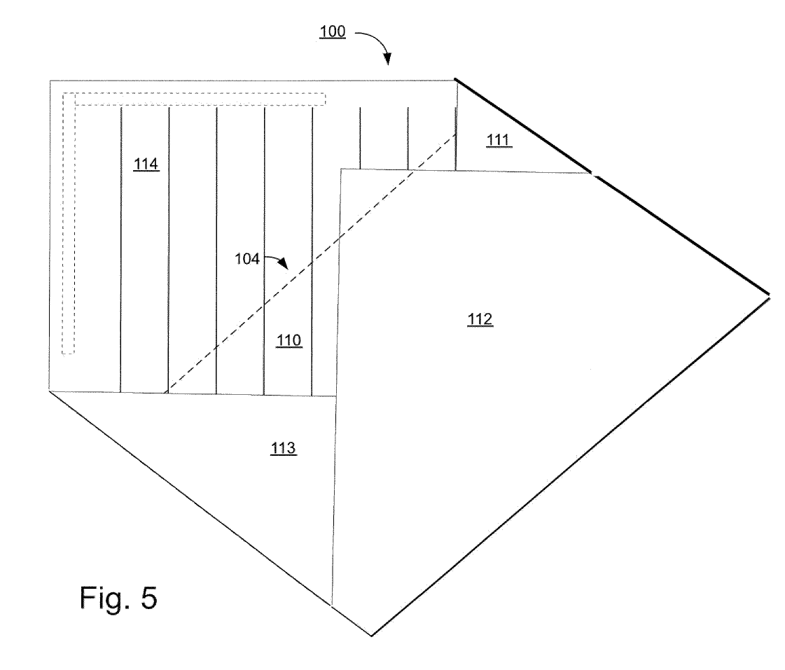

As shown in FIG. 5, flap 112 is folded along line 102 to cover and hold the inside flaps 111, 113. In FIG. 6, the top flap 114 is folded along line 104 to cover flap 112 and close the envelope. In the final, closed position, the folded flaps 111-114 are within an area that closely approximates section 110.

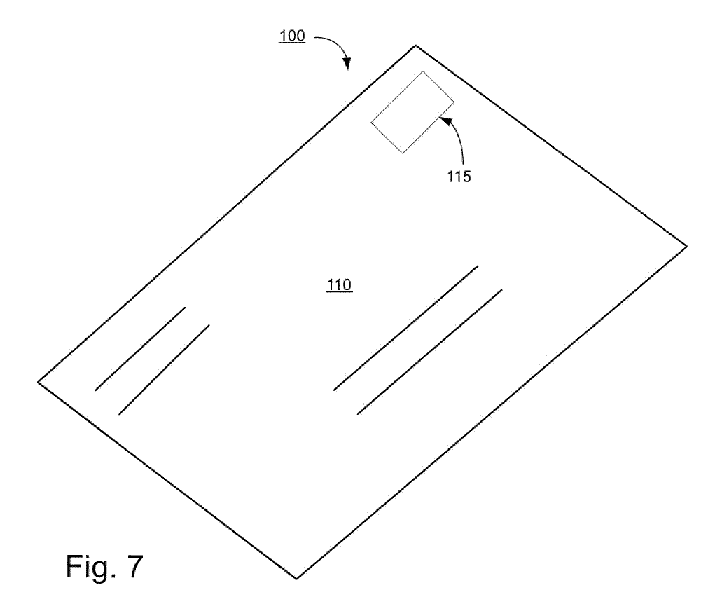

FIG. 7 shows the front side of the mailer 100 in the closed position. In the closed position, center section 110 forms the “face” of the envelope that includes the address information and postage 115.

Because the inside surface of the mailer 100 acts as a stationery writing surface, the user is saved the hassle and expense of having to buy separate envelopes and stationery. At the same time, because the mailer 100 folds into a closed envelope, the user still has the option of enclosing items in the folded mailer, e.g., photos, checks, etc.

FIG. 8 shows the back side of the presently preferred embodiment of the mailer of the present invention having a detachable portion 802. The detachable portion 802 is removably attached to the mailer 100 by perforations 804, allowing a recipient to remove the detachable portion from the remaining part of the mailer 100. An adhesive strip 220 removably attached to the mailer via perforations 806 adjacent to the detachable portion 802 is also included in the preferred embodiment of the mailer. It should be noted that while the detachable portion 802 of the mailer 100 of the preferred embodiment is located on the section 114 shown in FIG. 8, alternate embodiments of the invention may include a detachable portion on any of the other sections of the mailer as well. In fact, it is only necessary that one edge of the detachable portion be used to removably secure said portion to the rest of the mailer. Further, the detachable portion may be composed of various dimensions and in other proportions than that which is shown in FIG. 8. Moreover, alternate embodiments of the mailer may not include removably attached adhesive strips or any adhesive strips at all.

The detachable portion 802 may include any number of various items that are desired to be sent to a recipient and intended to be retained. For example, information typically appearing on a business card may be printed on the detachable portion, allowing a recipient to detach the business card to retain and optionally discard the rest of the mailer. Other contemplated uses of the detachable portion include tickets, invitations, coupons, photographic images, bank checks, and any other item that may be detachably secured to the mailer. Those of ordinary skill in the art will appreciate that the mailer, including the detachable portion and any correspondence to appear on the back side, may be printed at the same time, thus relieving the sender of separately printing the correspondence and the detachable portion and assembling them for mailing.

In an alternate embodiment, the mailer 100 may take the form of a postcard. In this embodiment, center section 110 forms the area upon which the postcard picture is printed, and the address information is printed on the outside of flap 114 when it is in the closed position shown in FIG. 6.

An advantage of this embodiment over traditional postcards is that the reverse side (shown in FIG. 2) provides considerably more writing space than a postcard. With a traditional postcard, much of the reverse side is taken up with the address information, leaving a small area for writing a message to the recipient. With the present invention, not only is the writing area on the reverse side much larger than a postcard, none of it has to be devoted to address information (which is printed on the outside of flap 114). In addition, because the writing area of the mailer is enclosed when the mailer is folded into an envelope, the message is kept private, unlike traditional postcards.

As a further option to the postcard embodiment of the mailer 100, the fold lines/creases 101-104 can be perforated to allow the recipient to remove the flaps 111-114, leaving only the center section 110 with the picture on it.

In addition to personal applications, the mailer of the present invention can be used for commercial purposes in situations that traditionally use letters and envelopes. The classic example of this is a bill statement, which typically encloses a statement (usually with a detachable payment coupon) and a return envelop within a larger envelope. Depending on the length and complexity of the statement, the entire statement could be printed on the back side of a mailer of the present invention with the detachable payment coupon, and with the return address and postage on the front as shown in FIGS. 1 and 7.

In those situations that preclude printing the entire statement on the back of a mailer (e.g., the statement is several pages and/or the user wishes to keep a copy for his or her records), a payment coupon summarizing the statement could be printed on the mailer. Eliminating the need to include a payment coupon in a return envelop with payment is not only more convenient for the recipient paying the bill but also reduces paper use and costs for the party sending the bill. For large companies (e.g., banks, financial institutions), this reduced paper usage can be substantial.

By combining stationery with envelope, a parcel of lighter weight is formed allowing for a greater number of parcels to be shipped for a given weight. This is an advantage considering the increasing expense of transporting freight over long distances as well as the cost of local delivery.

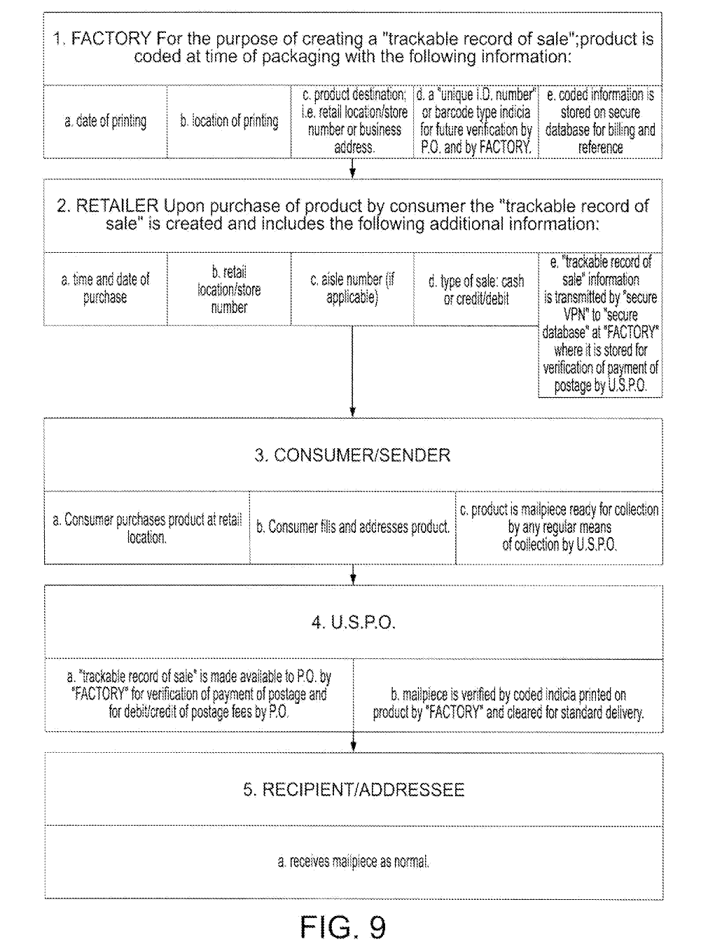

Referring now to FIG. 9, a flow diagram illustrating a method for collecting and storing information pertaining to the manufacture and sale of the mailer of the present invention. A first step of the method includes printing a unique coded identifier on each mailer at the manufacturer (factory) 1 where the mailer is manufactured. This provides a degree of traceability not found currently in the standard types of mail being processed by the Post Office. The unique coded identifier and postage is to be printed on each mailer 1d at the time of packaging by means of ink-jet, laser or similar printing mechanism capable of creating a block of information (such as a barcode) that is coded to include: 1.) the date of printing 1a; 2.) the location of printing 1b; 3.) the product destination 1c (retail location, store number, business address, etc.), and any other pertinent information concerning the mailer. The next step of the method is that the unique coded identifier, and the aforementioned information that is associated with said identifier, is stored on a secure database 1e at the manufacturer (factory) for later use.

Still referring to FIG. 9, a next step of a method of the present invention involves the retailer 2 involved in the sale of the mailer to consumers. Information pertaining to the sale of the mailer is recorded by the retailer at the time of sale of the mailer and stored by the retailer. Such information pertaining to the sale of the mailer may include: 1.) the time and date of purchase of the mailer 2a; 2.) the retail location/store number where the mailer is sold 2b; 3.) the aisle number where the mailer is sold 2c; 4.) the payment method used to purchase the mailer 2d, and any other information pertinent to the sale of the mailer. The information is stored by the retailer and transmitted to the manufacturer (factory) via a secure virtual private network (VPN) 2e or other means for electronic communications.

The consumer 3, after purchasing 3a the mailer having the unique coded identifier at the retail location, may prepare the mailer (including the addition of any written correspondence) for mailing by addressing it 3b. The mailer is now ready for mailing by any regular means of collection by the United States Postal Service (U.S.P.O.) 3c. When in possession of the U.S. Postal Service 4, the Postal Service may request that information pertaining to the payment of postage of the mailer be made available by the manufacturer 4a (factory). The Postal Service will be able to request information from the manufacturer by providing the unique coded identifier. After the postage payment information is made available by the manufacturer 4a (factory), the Postal Service 4 will be able to verify 4b that the postage in connection with the mailer has been paid. Subsequently, the recipient 5 of the mailer will receive it in accordance with the delivery practices of the Postal Service 5a.

In an alternate embodiment, postage and other information including: 1.) The number of units for a given package; 2.) The current rate of postage (e.g., in U.S. dollars for domestic use, adaptable for exchange in other countries); 3.) A sequential unit number for the location of each mailer in the package; 4.) The time, date and location of printing/packaging; and 5.) Information corresponding to a printed UPC symbol located on the package exterior for the purpose of activation of postage printed on the package contents (mailers) is printed on each mailer. The information is formatted to comply with existing electronic code reading equipment used by U.S. Post Office and other national postal services so as to make the creation of new equipment or modification of existing equipment unnecessary.

In a further alternate embodiment, the UPC symbol is printed on a page of the mailer inserted into the package containing numerous mailers and made visible from the exterior of the package. Information contained in the UPC symbol will provide for activation of package contents at the time of purchase, thereby allowing an electronic record of sale to be created. The newly created electronic record of sale will include information such as: 1.) point of sale; 2.) location of sale; 3.) time and date of purchase; and 4.) date of distribution to retail market or other location.

The electronic record of sale produced by the present invention has law enforcement and security advantages as well, which become apparent when considering the threat of terrorism and other crimes by mail. Tracing the origin of a letter to a point prior to the mailbox can prove to be a daunting task even for the most diligent investigator. Other systems call for the consumer to provide personally identifying information allowing them to be data-based according to memberships in social groups or clubs, country of origin, religious preference, etc. Due to the increasing number of consumers making purchases by credit/debit cards this information will be readily provided along with the additional information such as area of residence, purchase history, etc. These features allow the electronic record of sale to create a powerful and unparalleled tool for investigation of criminal and terrorist acts as well as for generalized analysis of consumer trends.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A foldable, one-piece mailer comprising:
a.) a sheet having a front side and a back side, said front side having a portion upon which postage and a recipient's address may appear, said back side having a means for visibly indicating sections of the mailer that are intended to be folded for mailing; and
b.) a detachable portion that is removably attached to said mailer.

2. The foldable, one-piece mailer of claim 1, further comprising one or more adhesive strips attached to said mailer.

3. The foldable, one-piece mailer of claim 2, further comprising postage appearing on said front side.

4. The foldable, one-piece mailer of claim 3, wherein said postage comprises a unique coded identifier.

5. The foldable, one-piece mailer of claim 4, wherein said unique coded identifier may be associated with information selected from the group consisting of: the date the mailer was printed, the location the mailer was printed, the location where the mailer is to be sold, the time the mailer is sold to a consumer, the date the mailer is sold to a consumer, the aisle number of a retail establishment where the mailer is sold, and the method of payment used by a consumer in purchasing said mailer.

6. The foldable, one-piece mailer of claim 5, wherein said detachable portion is removably attached to said mailer via perforations along at least one edge of said detachable portion.

7. The foldable, one-piece mailer of claim 6, wherein at least one of said adhesive strips is removably attached to said mailer.

8. The foldable, one-piece mailer of claim 7, wherein said detachable portion comprises one of an item selected from the group consisting of: a business card, a ticket, an invitation, a coupon, a bank check, and a photographic image.

9. The foldable, one-piece mailer of claim 8, wherein said means for visibly indicating sections of the mailer that are intended to be folded for mailing include dotted lines printed on said back side delineating borders of said sections.

10. The foldable, one-piece mailer of claim 8, wherein said means for visibly indicating sections of the mailer that are intended to be folded for mailing include visible creases appearing on said back side delineating borders of said sections.

11. A method for collecting and storing information pertaining to the manufacture and sale of a mailer comprising the following steps:
a.) manufacturing a foldable, one-piece mailer comprising a sheet having a front side and a back side, said front side having a portion upon which postage and a recipient's address may appear, said back side having a means for visibly indicating sections of the mailer that are intended to be folded for mailing;
b.) printing a unique coded identifier on said mailer; said unique coded identifier being associated with information pertaining to the manufacture of said mailer;
c.) storing said information pertaining to the manufacture of said mailer in an electronic database;
d.) associating information pertaining to a sale of said mailer with said unique coded identifier;
e.) transmitting said information pertaining to the sale of said mailer to a third party.

12. The method of claim 11 wherein said mailer further comprises a detachable portion removably secured to said mailer.

13. The method of claim 12 wherein information pertaining to the manufacture of said mailer includes information selected from the group consisting of: the date the mailer was printed, the location the mailer was printed, and the location where the mailer is to be sold.

14. The method of claim 13 wherein information pertaining to a sale of said mailer includes information selected from the group consisting of: the location where the mailer is sold, the time the mailer is sold to a consumer, the date the mailer is sold to a consumer, the aisle number of a retail establishment where the mailer is sold, and the method of payment used by a consumer in purchasing said mailer.

15. The method of claim 14 wherein said unique coded identifier is associated with information pertaining to prepaid postage.

16. The method of claim 15, further comprising the step of providing said mailer to a postal delivery service.

17. The method of claim 16, further comprising said postal delivery service communicating with said third party to obtain information pertaining to said prepaid postage.
